(19) United States
(12) Patent Application Publication
(10) Pub. No.: US 2020/0279469 A1
(43) Pub. Date: Sep. 3, 2020

(54) RADIO FREQUENCY DETECTOR

(71) Applicant: 9013733 CANADA INC., Cambridge (CA)

(72) Inventors: David S. Giessel, Cambridge (CA); Bruce Hildesheim, Cambridge (CA)

(73) Assignee: 9013733 CANADA INC., Cambridge (CA)

(21) Appl. No.: 16/805,498

(22) Filed: Feb. 28, 2020

Related U.S. Application Data
(60) Provisional application No. 62/859,749, filed on Jun. 11, 2019.
(60) Provisional application No. 62/812,183, filed on Feb. 28, 2019.

(51) Int. Cl. G08B 21/18

(52) U.S. Cl. CPC G08B 21/182

(57) ABSTRACT

Implementations of a wearable radio frequency (RF) detector are provided. The wearable RF detector is configured to monitor environmental electromagnetic radiation and comprises a high sensitivity, high linearity RF detection circuit that is paired with a compact, broadband, non-resonant antenna. This combination enables a physically small, yet accurate, detector to be built. An exemplary implementation of the wearable radio frequency detector comprises: an electronic circuit configured to monitor environmental electromagnetic radiation within a frequency band of interest; the electronic circuit comprises a radio frequency detection circuit and a non-resonant antenna that lacks resonant modes in the frequency band of interest; wherein the radio frequency detection circuit, in conjunction with the non-resonant antenna, facilitates the monitoring of environmental electromagnetic radiation within the frequency band of interest. In some implementations, the electronic circuit is contained within a housing that includes a wristband.

### CROSS REFERENCE TO RELATED APPLICATION

This application claims the benefit of U.S. Provisional Application Ser. No. 62/812,183, which was filed on Feb. 28, 2019, and U.S. Provisional Application Ser. No. 62/859,749, which was filed on Jun. 11, 2019, the entireties of which are incorporated herein by reference.

### TECHNICAL FIELD

This disclosure relates to implementations of a radio frequency (RF) detector. In particular, the present invention is directed to implementation(s) of a wearable radio frequency detector.

### BACKGROUND

Increasing use of wireless technology in consumer and household electronics has resulted in significantly elevated levels of environmental microwave radiation in recent years. These elevated levels of microwave radiation are beginning to produce physiological effects in the general public. These effects are manifesting as physiological symptoms (e.g., conscious sensations, disrupted sleep, etc.) as well as cellular damage (e.g., DNA strand breaks, elevated cell apoptosis, etc.).

Accurately monitoring broad microwave bands (e.g., 1 GHz to about 12 GHz) has typically required specialized antennas connected to large and expensive lab test equipment. Low cost, small, battery powered microwave detectors have only recently become available. These detectors have limited detection bandwidth (a few GHz), poor response linearity across the measurement range, and are too large to conveniently carry.

To continuously monitor elevated microwave radiation levels in modern urban environments; a wide bandwidth, high linearity, physically small detector with all-day battery life provides the ideal solution. A combination of these features in a single device has not, to date, been attainable.

Accordingly, it can be seen that needs exist for the radio frequency detector disclosed herein. It is to the provision of a radio frequency detector that is configured to address these needs, and others, that the present invention is primarily directed.

### SUMMARY OF THE INVENTION

Implementations of a wearable radio frequency (RF) detector are provided. The wearable RF detector is configured to monitor environmental electromagnetic radiation and comprises a high sensitivity, high linearity RF detection circuit that is paired with a compact, broadband, non-resonant antenna. This combination enables a physically small, yet accurate, detector to be built. An electronic circuit that includes efficient physical electronics, a power management logic, and the use of leading-edge battery technology enables the radio frequency detector to operate for a full day and to remain small enough to be “wearable” (e.g., a wrist watch, a pendant, etc.). By combining the aforementioned elements into a convenient and unobtrusive wearable device, continuous monitoring of electromagnetic radiation in a wearer's surrounding environment becomes practical.

An exemplary implementation of the wearable radio frequency detector comprises: an electronic circuit configured to monitor environmental electromagnetic radiation within a frequency band of interest; the electronic circuit comprises a radio frequency detection circuit and a non-resonant antenna that lacks resonant modes in the frequency band of interest; wherein the radio frequency detection circuit, in conjunction with the non-resonant antenna, facilitates the monitoring of environmental electromagnetic radiation within the frequency band of interest.

In some implementations, the electronic circuit is contained within a housing that includes a wristband.

### BRIEF DESCRIPTION OF THE DRAWINGS

FIG. 1 illustrates a block diagram of a wearable radio frequency detector constructed in accordance with the principles of the present disclosure.

FIGS. 2-6 illustrate the wearable radio frequency detector shown in FIG. 1, or portions thereof.

FIG. 7 illustrates a partial enlarged view of FIG. 1, wherein an example power management logic for the wearable radio frequency detector is shown.

Like reference numerals refer to corresponding parts throughout the several views of the drawings.

### DETAILED DESCRIPTION

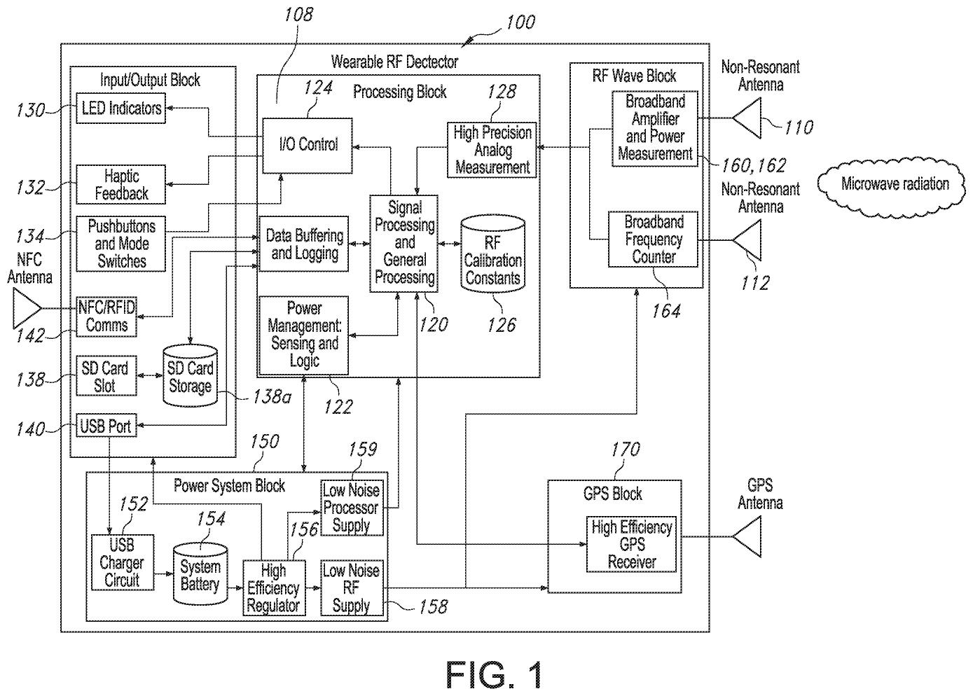

FIG. 1 illustrates a block diagram of a wearable radio frequency (RF) detector 100 constructed in accordance with the principles of the present disclosure. The RF detector 100 is configured to monitor environmental electromagnetic radiation (e.g., microwaves).

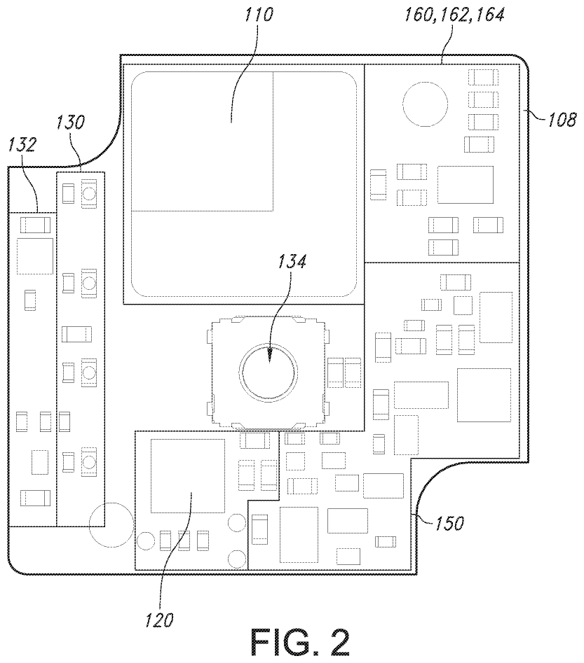

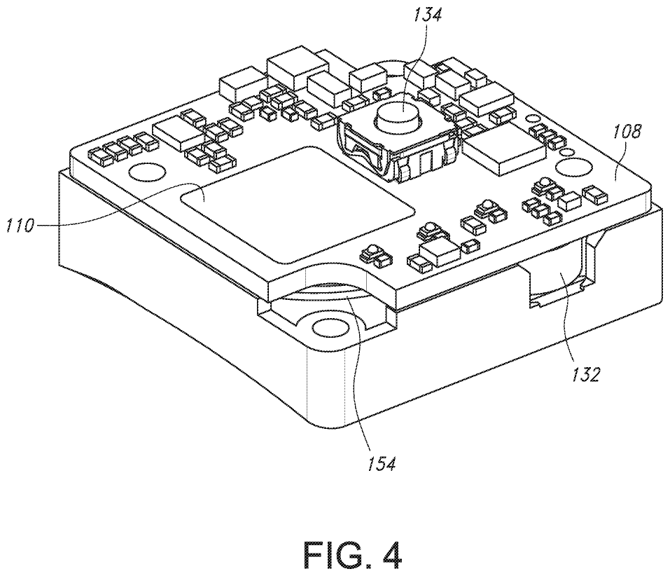

Integration of the circuit components into a physically compact space with minimal interference is a significant challenge for an RF measurement device. Typically, antenna size and spacing requires an RF measurement device to be physically large (handheld or larger). One or more implementations of the wearable RF detector 100 solve these challenges by carefully packaging circuit components around a non-resonant antenna 110. Further, selection of low electro-magnetic emission (EMI) circuit components combined with mechanical packaging that places the antenna 110 in an “open sky” position on the face of the detector 100 enables good performance in a much smaller space than existing devices (note antenna 110 location in FIGS. 2 and 4). An example of this physical integration is shown in FIGS. 2-6. Integrating the circuit components in a way that minimizes physical size and maximizes RF measurement performance is described in detail below.

In some implementations, the configuration of the non-resonant antenna 110 is key to designing a wearable RF detector 100 that is both physically small and broad in frequency response, typically exceeding one order of magnitude in the microwave band (e.g., below 1 GHz to above 10 GHz). For flat response across a frequency band, the non-resonant antenna 110 is designed to lack resonant modes in the frequency band of interest. It is only resonant at significantly higher frequencies that are out of the measurement band. Resonant modes are typically employed to yield high-sensitivity, narrow-frequency, in-band response (e.g., as required by WiFi and Bluetooth devices), as this improves narrow-band performance. Using an antenna 110 that lacks significant resonant gain for in-band measurement is a counter-intuitive approach that flattens the in-band frequency response without requiring a complex antenna, frequency selective filtering circuitry, or a combination thereof.

To achieve high sensitivity, despite the low gain of the non-resonant antenna 110 design, a high-sensitivity/low-noise RF detection circuit 160 is employed. This RF detection circuit 160 includes a high-gain, low-noise, broad-band amplifier 162 connected to a high-sensitivity, high-speed, low-noise analog-to-digital converter 128. This RF detection circuit 160 provides a simple, compact, and cost-effective means of measuring electromagnetic radiation with a band of interest (e.g., the microwave band, or a portion thereof).

Further, the non-resonant design of the antenna 110 has the added benefit of low gain and provides for consistent measurement regardless of the orientation of the RF detector 100. This is especially important for a wearable RF detector 100, as its orientation is tied to a wearer's body position.

In some implementations, the wearable RF detector 100 comprises a housing 102 with a wristband 106 (see, e.g., FIGS. 2-6), the housing 102 contains an electronic circuit 108 configured to monitor environmental electromagnetic radiation.

As shown in FIG. 1, in some implementations, the electronic circuit 108 of the wearable RF detector 100 may comprise a microprocessor 120 that includes a nonvolatile memory, I/O (input/output) devices (e.g., LED indicators 130, a haptic feedback device 132, and a ON/OFF switch 134), a power system 150, and RF measurement components (e.g., an RF detection circuit 160) that use at least one non-resonant antenna 110, or a suitable combination thereof. In some implementations, the wearable RF detector 100 may further comprise I/O (input/output) interfaces (e.g., a SD card slot 138, a USB port 140, a near field communication (NFC) device 142) and/or a GPS subsystem 170. In some implementations, one or more components of the electronic circuit 108 may be mounted on a printed circuit board (PCB) and conductively connected together thereby (see, e.g., FIG. 2).

The microprocessor 120 of the electronic circuit 108 is configured to enable the wearable RF detector 100 to perform the functions that are implied and/or specified herein. In some implementations, the nonvolatile memory may be an integral part of the microprocessor 120, or a discrete component.

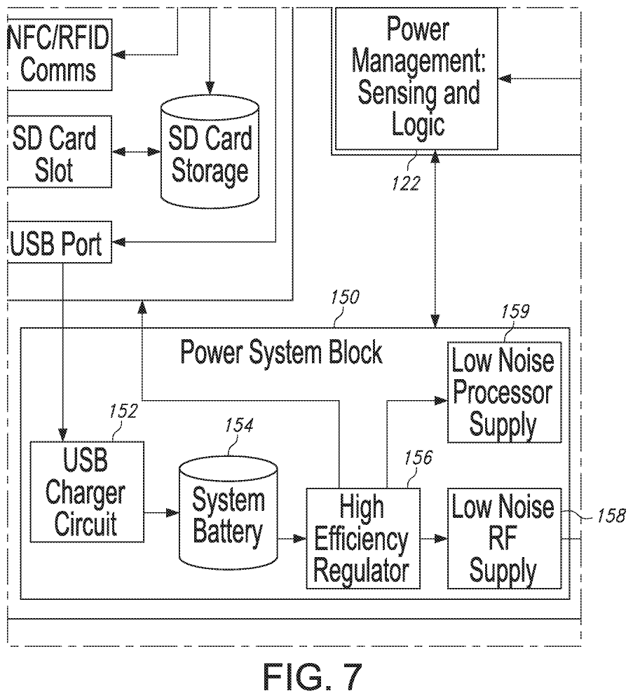

As shown in FIGS. 1 and 7, in some implementations, the microprocessor 120 includes an adaptive power management algorithm 122 that may be stored in the nonvolatile memory. This power management algorithm 122 uses measured RF values, local device 100 motion (an onboard accelerometer being used to detect motion), and, in some implementations, global device 100 movement (a GPS subsystem 170 being used to track movement) to set RF measurement frequency and period, as well as the corresponding sleep/low-power time between RF measurements. This adaptive power management algorithm 122 is useful because continuous measurement of high speed/high bandwidth electromagnetic radiation is energy intensive. The necessary analog amplifier circuits and high-speed digital processing necessitate careful power management to achieve good battery life, especially with compact/low capacity batteries.

As shown in FIG. 1, one or more I/O controllers 124 may be provided to interface an I/O device (e.g., LED indicators 130, a haptic feedback device 132, and a ON/OFF switch 134) with one or more components (e.g., the microprocessor 120) of the electronic circuit 108.

In some implementation, RF calibration constants 126 may be stored in the nonvolatile memory of the microprocessor 120. The RF calibration constants 126 provide a calibrated baseline used by the microprocessor 120 to correct for environmental factors (e.g., temperature) that can affect the accuracy of RF measurements recorded by the RF detector 100. In this way, consumer grade (i.e., cheaper) electrical components can be used to assemble the electronic circuit 108.

In some implementations, the electronic circuit 108 may include an analog-to-digital convertor 128 that facilitates high precision analog measurement of electromagnetic radiation detected by the non-resonant antenna 110. In some implementations, the analog-to-digital convertor 128 may be an integral part of the microprocessor 120, or a discrete component.

As shown in FIGS. 1, 2, and 6, in some implementations, the electronic circuit 108 of the RF detector 100 may include four light emitting diodes (LEDs) 130 that are visible through openings 103 in the face of the housing 102. The LEDs 130 provide visual feedback to the wearer regarding the power of electromagnetic radiation being measured by the RF detector 100. In some implementations, the number of LEDs 130 illuminated acts as a power level indicator for in-band frequencies being detected, each illuminated LED 130 corresponding to a relative order of magnitude (˜10 dBs). In some implementations, the electronic circuit 108 may include more than four or less that four LEDs 130.

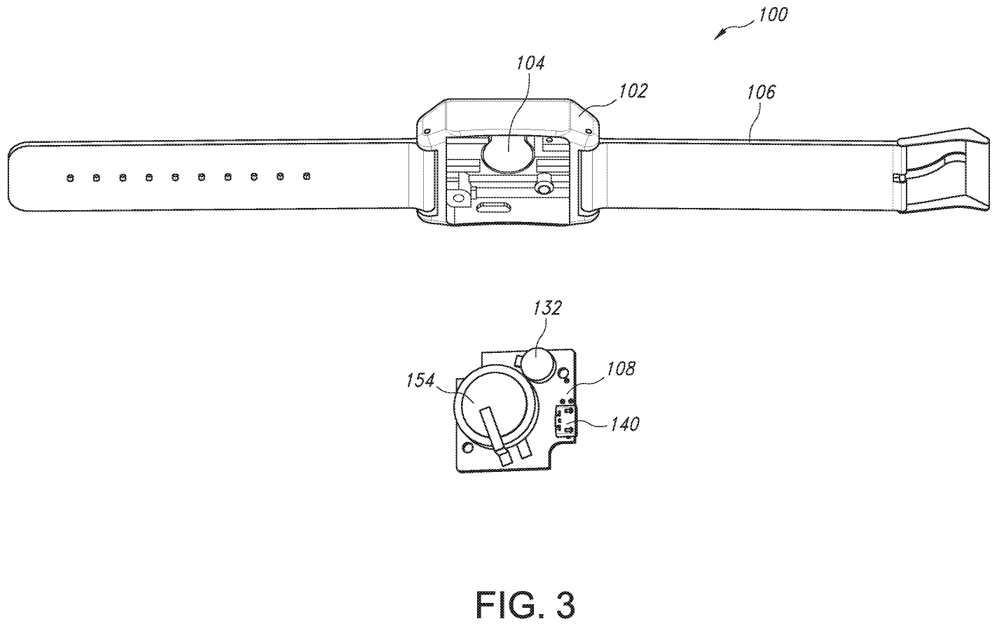

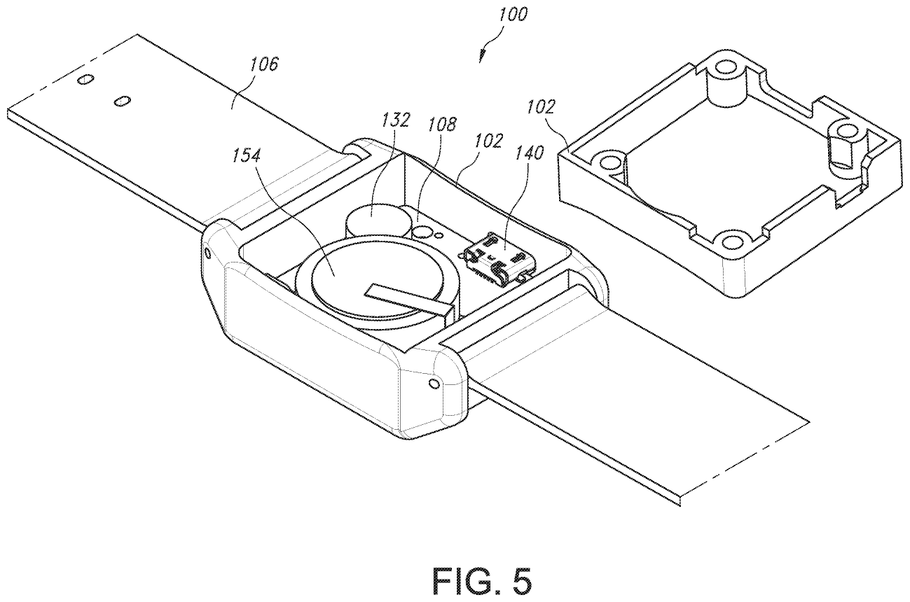

As shown in FIG. 1, in some implementations, the electronic circuit 108 includes a haptic feedback device 132 since wearable detectors are the least obtrusive when they provide non-visual indicators, such as haptic feedback (e.g., vibration). The user is provided with haptic feedback when electromagnetic radiation having a power level that meets, or exceeds, a set threshold value is measured by the RF detector 100. The threshold value that triggers haptic feedback is set during manufacture of the RF detector 100, but, in some implementations, the threshold value can be set by the user. In some implementations, the wearable RF detector 100 provides haptic feedback via a linear resonant actuator (LRA) 132. LRAs provide high amplitude vibration with minimal power consumption. Also, unlike brushed motor eccentric rotating mass (ERM) actuators, LRAs are brushless and emit no electro-magnetic interference (EMI) that could interfere with measurement of electromagnetic radiation by the RF detector 100. Additionally, the haptic feedback device 132 (i.e., the LRA) is packaged below the circuit board ground plane, under all active measurement elements (see, e.g., FIGS. 3 and 5).

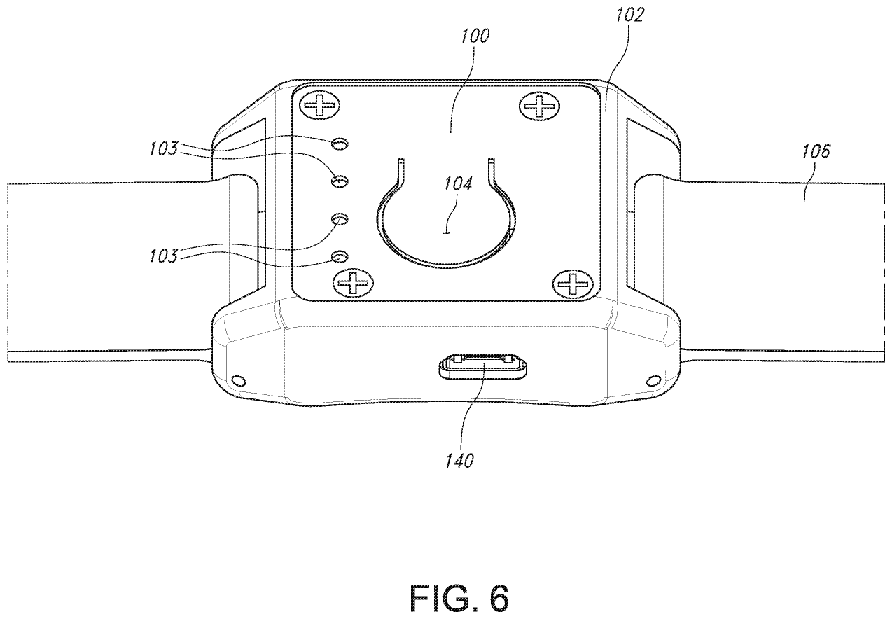

As shown in FIGS. 1-2, and 4, the electronic circuit 108 includes an ON/OFF switch 134 that can be used to turn the RF detector ON and OFF. In some implementations, the face of the housing 102 includes a flexible contact member 104 that a wearer can press to toggle the ON/OFF switch 134 (see, e.g., FIG. 6).

As shown in FIG. 1, in some implementations, the electronic circuit 108 may include a Secure Digital (SD) card slot 138. In this way, removable non-volatile memory cards 138a can be used to expand the overall memory of the electronic circuit 108 and/or to update the system (i.e., makes changes to the microprocessor 120 and/or the nonvolatile memory) of the RF detector 100.

As shown in FIG. 1, in some implementations, the electronic circuit 108 may include a Universal Serial Bus (USB) port 140. The USB port 140 may be used to charge the system battery 154 (discussed in greater detail below) and/or to connect an external device (e.g., a personal computer) to the electronic circuit 108 of the RF detector 100. The external device may be used to collect data stored in the nonvolatile memory of the RF detector 100 and/or to update the system (i.e., makes changes to the microprocessor 120 and/or the nonvolatile memory).

As shown in FIG. 1, in some implementations, the electronic circuit 108 may include a near-field communication (NFC) device 142. The NFC device 142 may be used to collect data stored in the nonvolatile memory of the RF detector 100 and/or to wirelessly update the system (i.e., makes changes to the microprocessor 120 and/or the nonvolatile memory). In some implementations, communication protocol(s) for the NFC device 142 are stored in the nonvolatile memory of the electronic circuit 108.

As shown in FIGS. 1 and 7, in some implementations, the power system 150 of the RF detector 100 includes a USB charger circuit 152. The USB charger circuit 152 works in conjunction with the USB port 140 to charge the system battery 154. In some implementations, the system battery 154 may be a button cell, or another electrochemical cell having a suitable form factor.

As shown in FIGS. 1 and 7, in some implementations, the power system 150 of the electronic circuit 108 may include a switch-mode power supply (SMPS) 156 that acts as a high efficiency regulator. In some implementations, the SMPS 156 has a very lower power draw/low parasitic draw (e.g., under 10 micro amps) and is configured to keep the electronic circuit 108 of the RF detector 100 active using a minimal amount of system power.

As shown in FIGS. 1 and 7, in some implementations, the electronic circuit 108 of the RF detector 100 may include a linear regulator 158 that is positioned between the power source (i.e., the SMPS 156) and the RF measurement components (e.g., the RF detection circuit 160 and the broadband frequency counter 164). The linear regulator 158 acts as a low-noise power source for the RF measurement components of the electronic circuit 108, thereby allowing for accurate RF measurement. The linear regulator 158 is used because a power supply (e.g., the SMPS 156) generates noise that can negatively impact the accuracy of RF measurement. In some implementations, the linear regulator 158 may be configured to supply power to the GPS subsystem 170.

As shown in FIGS. 1 and 7, in some implementations, the electronic circuit 108 of the RF detector 100 may include a second linear regulator 159 that is positioned between the power source (i.e., the SMPS 156) and the microprocessor 120. The linear regulator 159 acts as a low-noise power source for the microprocessor 120, thereby allowing for accurate RF measurement.

As shown in FIG. 1 in some implementations, the RF measurement components of the electronic circuit 108 comprise an RF detection circuit 160 that includes a broadband amplifier 162, a broadband frequency counter 164, and at least one non-resonant antenna 110.

In some implementations, when used in conjunction with the non-resonant antenna 110, the RF detection circuit 160 facilitates frequency measurement of the dominant carrier frequency that is in-band (i.e., the highest power carrier frequency).

In some implementations, the broadband amplifier 162 (which includes a log amplifier) is configured to measure a logarithmic input and to provide a linear output used to calculate power and frequency of electromagnetic radiation picked up by the non-resonant antenna 110. In some implementations, the broadband amplifier 162 facilitates measurement of a broad-dynamic range of radio frequencies by the RF detection circuit 160. In some implementations, the broadband amplifier 162 is a discrete component of the electronic circuit 108 (not shown).

In some implementations, the broadband frequency counter 164 (e.g., a prescaler circuit) is configured to facilitate measurement of, and provide additional information about, the carrier frequency of a signal. The broadband frequency counter 164 is an analog divider configured to provide a highly divided multiple of the carrier frequency to the microprocessor 120, thereby allowing for a simple, low speed, measurement by the microprocessor 120. In some implementations, the broadband frequency counter 164 uses a separate non-resonant antenna 112 (see, e.g., FIG. 1). In some implementations, the broadband frequency counter 164 shares the non-resonant antenna 110 with the RF detection circuit 160 (not shown). In some implementations, the electronic circuit 108 of an RF detector 100 may not include a broadband frequency counter 164 (not shown).

In some implementations, the maximum dimensions of a non-resonant antenna 110, 112 are approximately ¼ the wavelength of the highest measurement frequency and/or 1/50 the wavelength of the lowest measurement frequency. For example, the non-resonant antenna 110, 112 could be a rectangular patch antenna having dimensions that are 1/25 of a wavelength at 1 GHz. Implementations of the non-resonant antenna 110, 112 design are scaled (i.e., dimensioned) depending on the frequency band(s) being measured (e.g., the microwave band). The small size of the antenna 110, 112, resulting from its intentionally non-resonant design, allows the wearable RF detector 100 to be significantly smaller than traditional designs employing industry standard broadband antennas (e.g. logarithmic-periodic antennas, or multiple frequency-selective antennas). Additionally, the antenna's 110, 112 lack of resonance in the measurement band allows it to be packaged in close proximity to nearby electronic elements without the significant performance degradation that typically occurs due to de-tuning effects. This proximity can be as little as 1/100 the wavelength for the frequency band being measured (e.g., approximately 3 mm at 1 GHz).

As shown in FIG. 1, in some implementations, the electronic circuit 108 may include a GPS subsystem 170. In some implementations, the use of a GPS subsystem 170 allows localization and time-stamping of electromagnetic power and frequency measurements, thereby providing the user with a rich dataset that can be used to map areas both geographically and temporally. This enables the wearable RF detector 100 to track changes in microwave radiation in a given environment across time. This data could be used for medical research, real-estate valuation, etc.

Although not shown in the drawings, it will be understood that suitable wiring connects the electrical components of the wearable RF detector 100 disclosed herein.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations are depicted in the drawings in a particular order, this should not be understood as requiring that such operations be performed in the particular order shown or in sequential order, or that all illustrated operations be performed, to achieve desirable results.

1. A wearable radio frequency detector comprising:
an electronic circuit configured to monitor environmental electromagnetic radiation within a frequency band of interest; the electronic circuit comprises a radio frequency detection circuit and a non-resonant antenna that lacks resonant modes in the frequency band of interest;
wherein the radio frequency detection circuit, in conjunction with the non-resonant antenna, facilitates the monitoring of environmental electromagnetic radiation within the frequency band of interest.

2. The radio frequency detector of claim 1, wherein the non-resonant antenna is a rectangular patch antenna.

3. The radio frequency detector of claim 1, wherein the frequency band of interest is the microwave band.

4. A wearable radio frequency detector comprising:
a housing with a wristband, the housing contains an electronic circuit configured to monitor environmental electromagnetic radiation within a frequency band of interest, the electronic circuit comprises a radio frequency detection circuit and a non-resonant antenna that lacks resonant modes in the frequency band of interest;
wherein the radio frequency detection circuit, in conjunction with the non-resonant antenna, facilitates the monitoring of environmental electromagnetic radiation within the frequency band of interest.

5. The radio frequency detector of claim 4, wherein the non-resonant antenna is a rectangular patch antenna.

6. The radio frequency detector of claim 4, wherein the frequency band of interest is the microwave band.

7. A wearable radio frequency detector comprising:
a housing with a wristband, the housing contains an electronic circuit configured to monitor environmental electromagnetic radiation within a frequency band of interest, the electronic circuit comprises: a microprocessor; an ON/OFF switch for the electronic circuit; a power source for the electronic circuit; and RF measurement components, the RF measurement components include a radio frequency detection circuit and a non-resonant antenna that lacks resonant modes in the frequency band of interest;
wherein the radio frequency detection circuit, in conjunction with the non-resonant antenna, facilitates the monitoring of environmental electromagnetic radiation within the frequency band of interest.

8. The radio frequency detector of claim 7, wherein the radio frequency detection circuit includes a broadband amplifier configured to measure a logarithmic input and to provide a linear output used to calculate power and frequency of electromagnetic radiation within the frequency band of interest.

9. The radio frequency detector of claim 8, wherein the electronic circuit comprises an analog-to-digital convertor connected to the radio frequency detection circuit, the analog-to-digital convertor facilitates analog measurement of electromagnetic radiation detected by the non-resonant antenna.

10. The radio frequency detector of claim 9 wherein the electronic circuit comprises a linear regulator positioned between the power source and the RF measurement components, the linear regulator acts as a low-noise power source for the RF measurement components of the electronic circuit.

11. The radio frequency detector of claim 7, wherein the frequency band of interest is the microwave band.
